(19) United States
(12) Patent Application Publication
(10) Pub. No.: US 2015/0349594 A1
(43) Pub. Date: Dec. 3, 2015

(54) Electric Pump

(71) Applicant: Johnson Electric S.A., Murten (CH)

(72) Inventors: Hong Liang ZHANG, Shenzhen (CN); Chuang YU, Shenzhen (CN); Dai Gang LI, Shenzhen (CN); Yan Ping REN, Shenzhen (CN)

(21) Appl. No.: 14/724,211

(22) Filed: May 28, 2015

(30) Foreign Application Priority Data
May 28, 2014 (CN) 201410232722.X

(51) Int. Cl. H02K 1/20; F04D 13/06; H02K 1/14

(52) U.S. Cl. CPC H02K 1/20; H02K 1/146; F04D 13/06

(57) ABSTRACT

An electric pump includes a pump housing, a motor and an impeller. The impeller is driven by the motor. The pump housing has an inlet and an outlet. The motor includes a stator and a rotor with an air gap formed there between. The stator includes a stator core having a yoke and teeth extending radially inwardly from the yoke. A stator winding is wound about each tooth. The teeth include a plurality of first teeth and a plurality of second teeth that are alternately arranged. Grooves are formed in the outer surface of the yoke corresponding to each of the first teeth, and the first teeth and the second teeth have different shapes, such that the stator core has a symmetrically distributed magnetic circuit.

### CROSS REFERENCE TO RELATED APPLICATIONS

This non-provisional patent application claims priority under 35 U.S.C. §119(a) from Patent Application No. 201410232722.X filed in The People's Republic of China on May 28, 2014, the entire contents of which are hereby incorporated by reference.

### FIELD OF THE INVENTION

This invention relates to electric pumps and in particular, to a liquid pump having a longer life.

### BACKGROUND OF THE INVENTION

Electric liquid pumps are widely used in the automotive industry. For instance, coolant pumps are used to supply coolant to an engine and fuel pumps are used to supply fuel to an engine. This type of electric pump includes a pump housing, a motor installed in or connected to the pump housing, and an impeller driven by the motor. The liquid, such as the coolant or fuel, is driven by the rotating impeller.

The motor is an important component in this type of electric pump. The motor runs all the time when the vehicle is operating. Therefore, the motor is required to operate steadily and have high reliability and long lifespan. The bearing for supporting the rotor is most prone to failure in the motor. If the bearing is worn out, the motor will no longer work normally. One of the min reasons for the bearing to fail is that the radial forces are unbalanced to a large degree, which increases friction between the rotor and the bearing.

Regarding the motor for use in the fuel pump or coolant pump, in a prior design by the present applicant, guide grooves are formed in an outer surface of a stator core, which act as fuel or coolant channels. In the prior design, windings are not wound around teeth of the stator corresponding to the guide grooves, and the windings are only wound around teeth of the stator that are staggered with the guide grooves. It has been found that this practice results in a large unbalanced radial force, which leads to wear of the bearing and affects the lifespan of the product.

In addition, the unbalanced radial forces also results in large noises.

### SUMMARY OF THE INVENTION

Thus, there is a desire for a motor structure, in particular, a motor stator which can eliminate or reduce the unbalanced radial forces. There is also a. desire for an electric pump employing the above motor structure.

Accordingly, in one aspect thereof, the present invention provides an electric pump comprising: a pump housing, including a volute; a motor accommodated by the pump housing; an impeller disposed in the volute and driven by the motor; the pump housing having an inlet and an outlet, the motor comprising a stator and a rotor disposed within the stator, with an air gap formed between the stator and the rotor, the stator comprising a stator core and a stator winding, the stator core comprising a yoke and a plurality of teeth extending radially inwardly from the yoke, wherein the stator winding is wound about each of the teeth, the teeth comprise a plurality of first teeth and a plurality of second teeth that are alternately arranged in a circumferential direction, guide grooves are formed in an outer surface of the yoke corresponding to each of the first teeth, and the first teeth and the second teeth have different shapes, such that the stator core has a symmetrically distributed magnetic circuit.

Preferably, a thickness of parts of the yoke adjacent the grooves is less than a thickness of parts of the yoke remote from the grooves, and a width of the first teeth in the circumferential direction is greater than a width of the second teeth in the circumferential direction.

Preferably, a winding slot is formed between adjacent teeth, the winding slot is of an asymmetric shape with respect to a slot center line, and portions of the winding slot on opposite sides of the slot center line have substantially the same area.

Preferably, each of the teeth comprises a tip, all tips of the teeth have the same shape and size and are uniformly distributed in the circumferential direction.

Preferably, the inlet, grooves and outlet sequentially communicate with each other to form a flow passage, such that at least a portion of liquid entering the pump via the inlet, flows through the flow passage and then flows out the outlet.

Preferably, the pump includes a control assembly, the control assembly and the motor form a chamber there between, and the chamber is in flow communication with the flow passage and in heat exchange relationship with the control assembly, Whereby liquid entering the chamber cools the control assembly.

According to a second aspect, the present invention provides a motor stator comprising a stator core and a stator winding, the stator core comprising a yoke and a plurality of teeth extending radially inwardly from the yoke, wherein the stator winding is wound about each of the teeth, the teeth comprise a plurality of first teeth and a plurality of second teeth that are alternately arranged in a circumferential direction, a guide groove is formed in an outer surface of the yoke corresponding to each of the first teeth, and the first teeth and the second teeth have a different shape, such that the stator core has a symmetrically distributed magnetic circuit.

Preferably, a thickness of parts of the yoke adjacent the grooves is less than a thickness of parts of the yoke remote from the grooves, and a width of the first teeth in the circumferential direction is greater than a width of the second teeth in the circumferential direction

Preferably, a winding slot is formed between adjacent teeth, the winding slot is of an asymmetric shape with respect to a slot center line, and a difference in the area of portions of the winding slot on opposite sides of the slot center line is less than 10%.

Preferably, each tooth comprises a tip, all tips of the teeth have the same shape and size and are uniformly distributed in the circumferential direction.

Preferably, a winding bracket is disposed at one or both ends of the stator core, the winding bracket comprising protrusions located adjacent the grooves and configured to restrain the stator winding from entering the corresponding groove.

In view of the foregoing, the pump includes the flow passage to cool the motor parts to improve the reliability of the motor. in addition, all teeth of the stator are wound with windings, the stator teeth aligned with the grooves and the stator teeth not aligned with the grooves have different thickness, the parts of the yoke adjacent the grooves and the parts remote from the grooves have different width, teeth are symmetrically distributed in the circumferential direction, and all the tips have the same shape and are symmetrically distributed in the circumferential direction. These design features give the motor balanced magnetic circuits of the stator, a periodically and symmetrically distributed air-gap magnetic field, and symmetrically distributed windings, thereby eliminating the unbalanced radial forces, reducing the motor noise and wear of the bearings and hence increasing the lifespan of the motor.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates an electric liquid pump according to the preferred embodiment of the present invention;

FIG. 2 is an exploded view of pump of FIG. 1;

FIG. 3 is a longitudinal sectional view of the pump of FIG. 1;

FIG. 4 illustrates a stator of a pump according to one embodiment;

FIG. 5 illustrates a stator core according to one embodiment;

FIG. 6 illustrates the magnetic circuit of a prior art motor;

FIG. 7 illustrates the magnetic circuit of the motor according to the preferred embodiment of the present invention;

FIG. 8 is a graph comparing unbalanced radial forces between the prior design and the new design according to the preferred embodiment of the present invention; and

FIG. 9 is a graph comparing the noise of the pump between the prior design and the new design.

### DETAILED DESCRIPTION OF THE PREFERRED EMBODIMENT

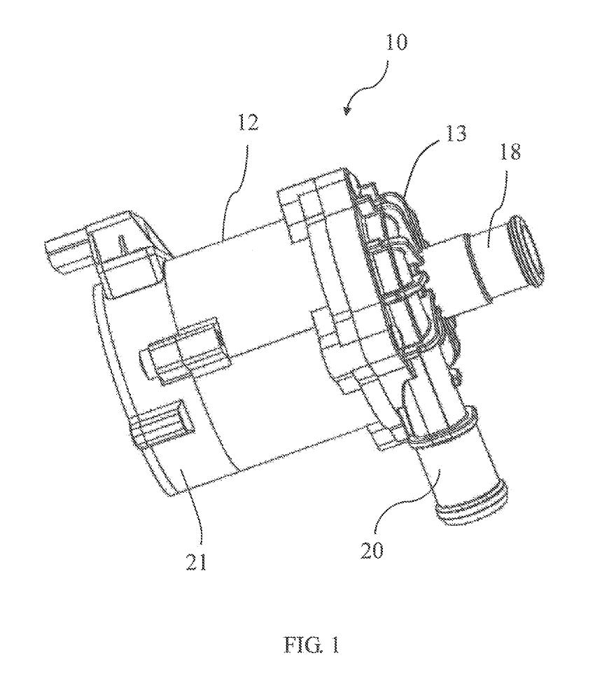

Referring to FIG. 1 to FIG. 3, the electric pump 10, in accordance with the preferred embodiment of the present invention, includes a pump housing 12, a volute 13 being a part of the pump housing, a motor 14 disposed in the pump housing 12, and an impeller 16 disposed within the volute. In this embodiment, the pump housing 12 includes a cylindrical body and two end covers connected to opposite ends of the cylindrical body. The pump volute 13 has an inlet 18 and an outlet 20. As the motor 14 rotates the impeller 16, liquid is drawn into the pump housing 12 via the inlet 18 and flows out of the pump housing 12 via the outlet 20. Depending on the use of the pump 10, the liquid may be coolant or fuel used, for example, in vehicles.

The pump 10 further includes a control assembly 21 for controlling operation of the motor 14. in the illustrated embodiment, the inlet 18 and outlet 20 are disposed at the same end of the pump 10, as part of the pump volute 13, and the control assembly 21 is disposed at an opposite end of the pump 10, In other words, the inlet 18 and outlet 20 are provided in the pump volute 13 disposed on one of the end covers of the pump housing 12, and the control assembly 21 is disposed on the other end cover of the pump housing 12. It should be understood that the inlet 18 and outlet 20 may be disposed at opposite ends of the pump 10 in another embodiment.

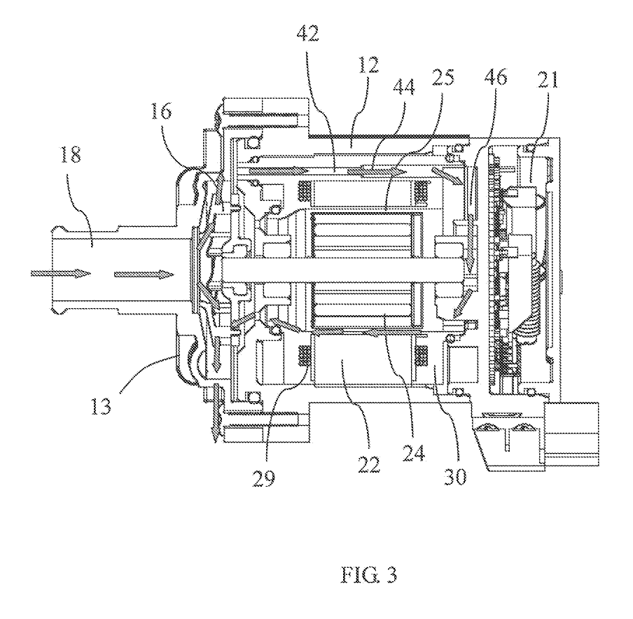

The motor 14 includes a stator 22 and a rotor 24 disposed within the stator 22 and rotatable with respect to the stator 22. An air gap 25 is formed between the stator 22 and rotor 24, as shown in FIG. 3,

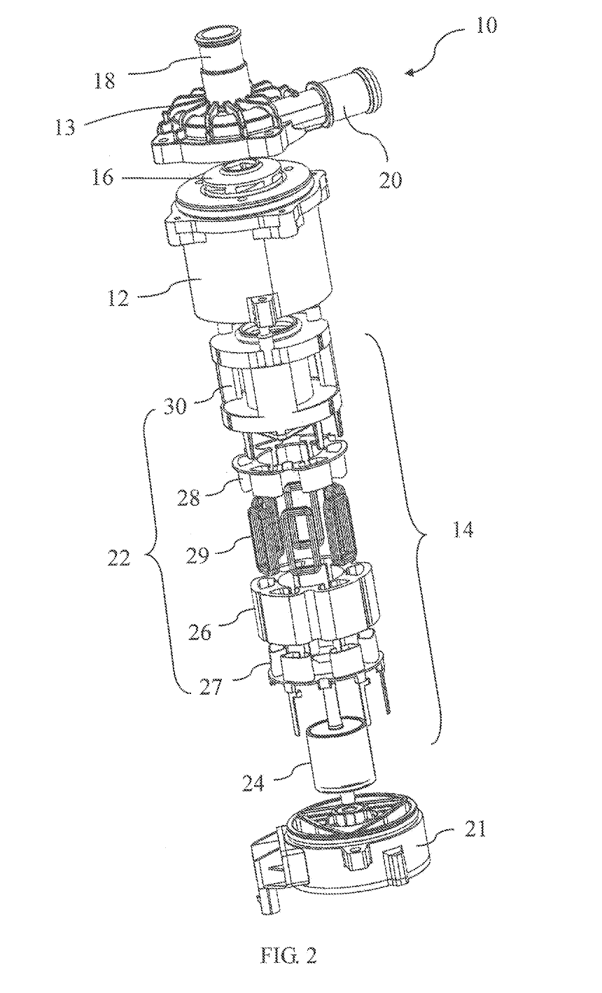

The stator 22 includes a stator core 26, windings 29, and an encapsulating structure 30. in order to isolate the liquid from the windings 29 and stator core 26, the encapsulation structure 30 is preferably formed over the stator core 26 by an over mold process. The encapsulation structure 30 may be formed from a material such as plastic or resin. Although the encapsulation structure 30 is illustrated as a separate structure in FIG. 2 for clearer illustration, it should be understood, however, that the encapsulation structure 30 and the stator core 26 and windings 29 form an integral body in practice. Similarly, a encapsulation structure may be formed over the rotor 24 to protect the rotor 24 from corrosion and to retain and position magnets on the rotor 24. It should be understood that the isolation of the liquid from the windings 29 and stator core 26 can be realized in another manner.

In the illustrated embodiment, the stator 22 further includes winding brackets 27 and 28 disposed on opposite axial ends of the stator core 26.

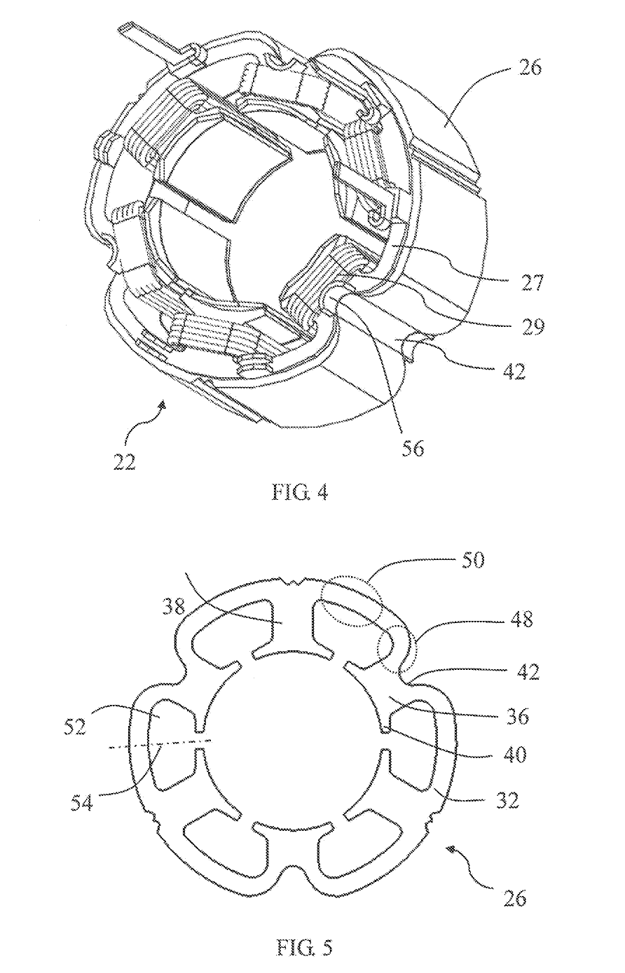

Referring also to FIG. 4 and FIG. 5, the stator core 26 is formed by a plurality of silicon steel laminations stacked together. These silicon steel laminations may be connected together by welding or another connecting means. The stator core 26 includes a ring-like stator yoke 32 and a plurality of teeth extending radially inwardly from inner surfaces of the stator yoke 32. Each tooth is wound by the stator winding 29. Each tooth has a tip 40 at a distal end thereof, and all the tips 40 have the same shape and are evenly distributed in a circumferential direction.

The teeth of the stator core 26 include a plurality of first teeth 36 and a plurality of second teeth 38. The first teeth 36 and second teeth 38 have different shapes and are alternately arranged in the circumferential direction. In the illustrated embodiment, the width of the first teeth is greater than the width of the second teeth 38, measured in the circumferential direction.

Grooves 42 are formed in the outer surface of the stator yoke 32, aligned with each first tooth 36, and no such grooves 42 are formed at locations corresponding to the second teeth 38. The grooves 42 extend from one axial end to the other axial end of the stator core 26. In some embodiments, the grooves 42 have the function of guiding liquid and therefore are referred to as guide grooves in those embodiments. For example, as shown in FIG. 3, when the pump is used as a coolant pump or fuel pump, the inlet 18, grooves 42 and outlet 20 sequentially communicate with each other to form a flow passage 44, such that at least a portion of the liquid enters the pump 10 via the inlet 18, flows through the flow passage 44 to the other end of the pump, flows through the air gap 24 between the rotor and the stator back to the first end of the pump and then flows out via the outlet 20. The liquid flowing through the flow passage 44 may cool heat generating elements (for example, stator 22 and control assembly 21 of the motor 14) adjacent the flow passage 44. A chamber 46 is formed between the control assembly 21 and the motor 14. Heat generating components of the control assembly 21 are in heat exchange relationship with the chamber 46 such that the chamber may act as a heat sink for the control assembly. The chamber 46 is in communication with the flow passage 44, such that the liquid enters or flows through the chamber 46 to cool the control assembly 21. In addition, the liquid flowing through the air gap 25 may provide a lubricating function.

In the illustrated embodiment, the grooves 42 extend radially inwardly into the first teeth 36, such that the grooves 42 have a large cross section, which effectively increases the delivery capability of the pump 10. The provision of the grooves 42 makes the thickness (the size in the direction perpendicular to the magnetic lines flowing through the yoke portions and perpendicular to the axial direction of the motor) of the parts of the yoke 32 adjacent the grooves 42 less than the thickness of the parts of the yoke 32 remote from the grooves 42. For example, as shown in FIG. 5, the encircled part 48 of the yoke 32 adjacent one of the grooves 42 has a thickness less than the thickness of the encircled part 50 of the yoke 32 remote from the groove 42. Because the width of the first teeth 36 is greater than the width of the second teeth 38, the above configuration may result in a uniformly distributed magnetic field of the stator 22 even though the grooves 42 are only formed at locations corresponding to the first teeth 36.

Winding slots 52 are formed between adjacent teeth for accommodating the windings 29. In the illustrated embodiment, each winding slot 52 is of an asymmetric shape with respect to a slot center line 54. In order to make the slots for adjacent windings have the same or approximately the same slot fill factor to effectively utilize the space, the portions of the winding slot 52 at opposite sides of the slot center line 54 have the same or substantially the same area. The winding slot 52 is of an asymmetric shape, which can hardly ensure the portions at opposite sides of the slot center line to have exactly the same area. If the difference of the area between the portions at opposite sides of the slot center line is not greater than 10%, it can be considered that the portions on the opposite sides of the slot center line has the same or substantially the same area. The slot center line refers to the line passing through a center of rotation of the stator core and a center point of a line connected between tips of adjacent teeth.

One or both of the winding brackets 27, 28 include protrusions 56 (FIG. 4). In the illustrated embodiment, both of the winding brackets 27, 28 have the protrusions 56. The protrusions 56 are formed on the winding brackets 27, 28 adjacent the grooves 42, to restrain the windings 29 from blocking the grooves 42 in case the windings 29 deform or become loose.

In the illustrated embodiment, the width of the first teeth 36 aligned with the grooves 42 is greater than the width of the second teeth 38 not aligned with the grooves 42. The thickness of the parts of the yoke 32 adjacent the grooves 42 is less than the thickness of the parts of the yoke 32 remote from the grooves 42. The teeth having the same shape are symmetrically distributed in the circumferential direction. All the tips of the teeth have the same shape and are uniformly distributed in the circumferential direction. All teeth 36, 38 are wound with the windings 29. One or more of the above design features give the motor 14 balanced magnetic circuits of the teeth, a periodically and symmetrically distributed air-gap magnetic field, and symmetrically distributed windings, thereby eliminating or significantly reducing the unbalance radial forces, thus reducing the motor noise and wear of the bearing and hence increasing the lifespan of the motor.

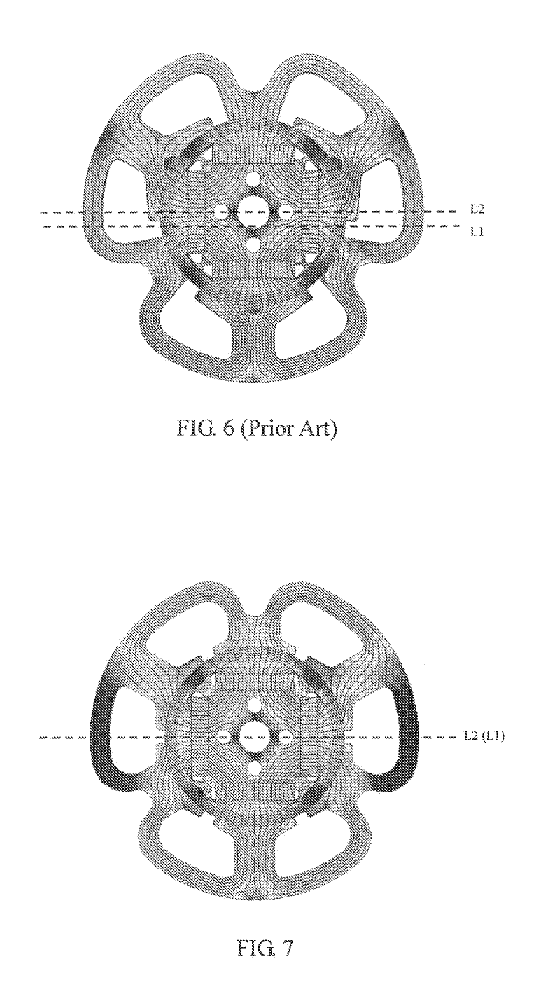

FIG. 6 to FIG. 9 depict the comparison results between the illustrated stator design and the prior stator design of this applicant.

As shown in FIG. 6, in the prior stator design, the yoke portions have the same thickness, and the teeth aligned with the grooves are not wound with windings, Therefore, once the stator windings are energized, the stator windings produce an induction field with a center line L1 deviating from a geometric center line L2 of the rotor, which results in an asymmetric magnetic field.

In the new design illustrated in FIG. 7, the geometric center line L2 of the rotor is aligned with the center line L1 of the stator induction field, thereby eliminating or significantly reducing the unbalanced radial forces.

FIG. 8 depicts a comparison of the unbalanced radial forces of the prior design with the new design. The unbalanced radial force of the prior design of the current applicant is 8N. The new design of the illustrated embodiment essentially eliminates this unbalanced radial force.

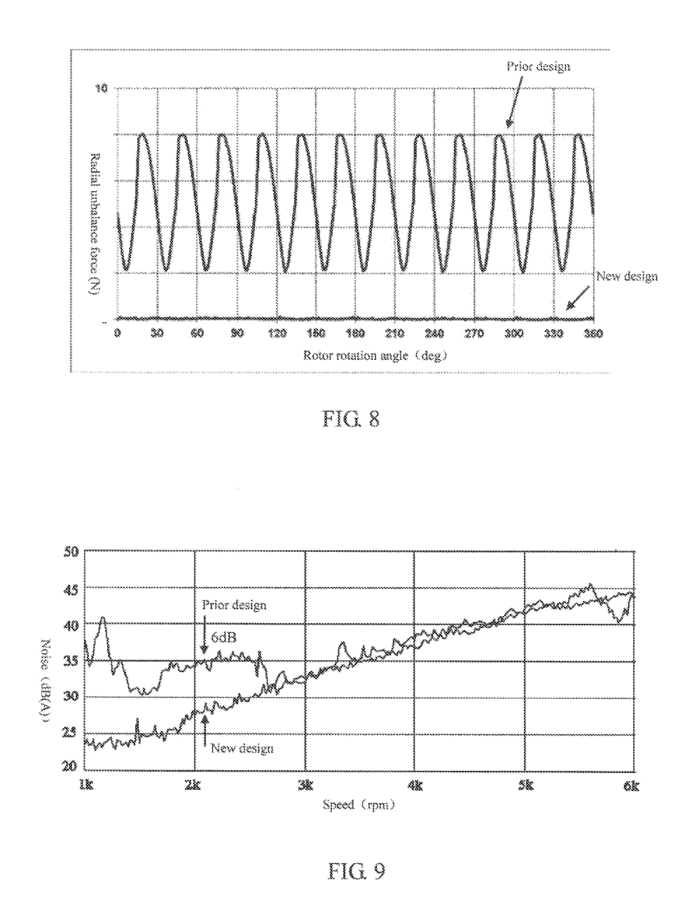

FIG. 9 depicts a comparison of the noise of the prior design with the new design. Because the new design of the illustrated embodiment eliminates unbalanced radial forces, the motor noise is significantly reduced. For example, at the speed of about 2000 RPM, the noise is reduced 6 dB when compared with the prior design.

After liquid enters the pump 10 via the inlet 18, a portion of the liquid is driven by the impeller 16 to flow out via the outlet 20. Another portion of the liquid flows through the flow passage 44 to provide cooling and lubrication function to the motor 14 and other components integrated with the motor, thereby improving the reliability of the motor.

In summary, in the illustrated embodiment, the pump includes a flow passage to cool the motor parts to improve the reliability of the motor. In addition, all teeth of the stator are wound with windings, the stator teeth aligned with the grooves and the stator teeth not aligned with the grooves have different thicknesses, the parts of the yoke adjacent the grooves and the parts remote from the grooves have different widths, teeth are symmetrically distributed in the circumferential direction, and all the tips have the same shape and are symmetrically distributed in the circumferential direction. These designs features give the motor balanced magnetic circuits of the stator, a periodically and symmetrically distributed air-gap magnetic field, and symmetrically distributed windings, thereby eliminating the unbalanced radial forces, reducing the motor noise and wear of the bearing and hence increasing the lifespan of the motor.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. An electric pump comprising: a pump housing, including a volume:
a motor accommodated by the pump housing;
an impeller disposed in the volute and driven by the motor;
the pump housing having an inlet and an outlet,
the motor comprising a stator and a rotor disposed within the stator, with an air gap formed between the stator and the rotor, the stator comprising a stator core and a stator winding, the stator core comprising a yoke and a plurality of teeth extending radially inwardly from the yoke,
wherein the stator winding is wound about each of the teeth, the teeth comprise a plurality of first teeth and a plurality of second teeth that are alternately arranged in a circumferential direction, guide grooves are formed in an outer surface of the yoke corresponding to each of the first teeth, and the first teeth and the second teeth have different shapes, such that the stator core has a symmetrically distributed magnetic circuit.

2. The pump of claim 1, wherein a thickness of parts of the yoke adjacent the grooves is less than a thickness of parts of the yoke remote from the grooves, and a width of the first teeth in the circumferential direction is greater than a width of the second teeth in the circumferential direction.

3. The pump of claim 1, wherein a winding slot is formed between adjacent teeth, the winding slot is of an asymmetric shape with respect to a slot center line, and portions of the winding slot on opposite sides of the slot center line have substantially the same area.

4. The pump of claim 1, wherein each of the teeth comprises a tip, all tips of the teeth have the same shape and size and are uniformly distributed in the circumferential direction.

5. The pump of claim 1, wherein the inlet, grooves and outlet sequentially communicate with each other to form a flow passage, such that at least a portion of liquid entering the pump via the inlet, flows through the flow passage and then flows out the outlet.

6. The pump of claim 5, further comprising a control assembly, the control assembly and the motor form a chamber there between, the chamber is in flow communication with the flow passage and in heat exchange relationship with the control assembly, whereby liquid entering the chamber cools the control assembly.

7. A motor stator comprising a stator core and a stator winding, the stator core comprising a yoke and a plurality of teeth extending radially inwardly from the yoke, wherein the stator winding is wound about each of the teeth, the teeth comprise plurality of first teeth and a plurality of second teeth that are alternately arranged in a circumferential direction, a guide groove is formed in an outer surface of the yoke corresponding to each of the first teeth, and the first teeth and the second teeth have a different shape, such that the stator core has a symmetrically distributed magnetic circuit.

8. The motor stator of claim 7, wherein a thickness of parts of the yoke adjacent the grooves is less than a thickness of parts of the yoke remote from the grooves, and a width of the first teeth in the circumferential direction is greater than a width of the second teeth in the circumferential direction

9. The motor stator of claim 7, wherein a winding slot is formed between adjacent teeth, the winding slot is of an asymmetric shape with respect to a slot center line, and a difference in the area of portions of the winding slot on opposite sides of the slot center line is less than 10%.

10. The motor stator of claim 7, wherein each tooth comprises a tip, all tips of the teeth have the same shape and size and are uniformly distributed in the circumferential direction.

11. The motor stator claim 7, further comprising a winding bracket at an end of the stator core, the winding bracket comprising protrusions located adjacent the grooves and configured to restrain the stator winding from entering the corresponding groove.
